(19) United States
(12) Patent Application Publication
(10) Pub. No.: US 2009/0310973 A1
(43) Pub. Date: Dec. 17, 2009

(54) Electroluminescent Emission Device for Optical Transmission in Free Space

(75) Inventors: Frederic Broyde, Maule (FR); Evelyne Clavelier, Maule (FR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: ZXTALK ASSETS, LLC, Wilmington, DE (US)

(21) Appl. No.: 12/281,972

(22) PCT Filed: Mar. 6, 2007
(86) PCT No.: PCT/FR2007/000403

§ 371 Date: Feb. 17, 2009

(30) Foreign Application Priority Data
Mar. 6, 2006 (FR) 0601952

(51) Int. Cl. H04B 10/00

(52) U.S. Cl. 398/128

(57) ABSTRACT

The invention relates to a transmitting device for transmission through space, using electromagnetic waves of the infrared and/or visible and/or ultraviolet bands produced by one or several diodes producing electroluminescent light.

The device is connected by its input terminals (1) to an a.c. energy distribution system. A mains filter (2) reduces the conducted electromagnetic disturbances produced by the power circuits comprising a rectifier (3), a power-factor-correction circuit (4), an auxiliary power supply (5) and a DC-to-DC converter (8). The output of the DC-to-DC converter (8) is connected to several high power light-emitting diodes connected in series (9). A receiving set for transmission via power distribution lines (6) delivers demodulated signals applied to the control circuitry (7) which provides the current command of the DC-to-DC converter (8) and the modulated current applied to the light-emitting diodes (9) through the modulation transformer (10), as a function of the demodulated signals and of the temperature which is measured by a temperature sensor (11). The produced light is modulated as a function of the demodulated signals.

### FIELD OF THE INVENTION

The invention relates to a transmitting device for transmission through space, using electromagnetic waves of the infrared and/or visible and/or ultraviolet bands produced by one or several diodes producing electroluminescent light.

### PRIOR ART

In the following, the word “light” will designate an electromagnetic radiation which may comprise visible light and/or ultraviolet light. In the following, the wording “light-emitting diode” will designate any type of diodes producing electroluminescent light. This light-emitting diode may for instance be an infrared light-emitting diode, a high-power white light-emitting diode incorporating a phosphor, an organic light-emitting diode, etc.

A transmitting device for free-space optical transmission, comprising one or more discharge lamps used as light source for transmission and a receiving set for transmission via power distribution lines, is described in the French patent application number 04 09939, entitled “Dispositif d'emission pour la transmission optique en espace libre”, and in the PCT application number PCT/IB2005/003309 entitled “Transmitting device for free-space optical transmission”. One of the advantages of these known devices is that the light produced is also used for lighting. In this case, the free-space optical transmission function may be added to the lighting function at a very low cost. It should be noted that, if luminaires using light-emitting diodes have been chosen for lighting, this advantage of the use of these known devices disappears.

It should also be noted that it is difficult to modulate in a frequency band of modulation larger than 10 kHz the light produced by a discharge lamp, whereas it is easy to modulate in a wide band the light produced by a light-emitting diode. This modulation of the light produced by light-emitting diodes may be obtained using several methods, which are appropriate for delivering a suitably modulated “diode current” produced by a “control device” to the different light-emitting diodes, the “diode current” flowing always in the same direction.

Lighting devices with a function of communication and comprising light-emitting diodes are described in the U.S. Pat. No. 6,956,338 of the United States of America entitled Analog control of light sources, and in the French patent application number 02 15359 entitled Dispositif d'éclairage à diodes électroluminescentes comportant un dispositif de communication et installation comportant un tel dispositif.

In particular, when the diode current comprises high frequency components, the person skilled in the art understands that it is desirable that the wiring between the control device and the light-emitting diode(s) be as short as possible. The advantages oficeeping this wiring short relate, for instance, to electromagnetic compatibility, electrical safety, or the efficiency of the whole installation. In practice, a short wiring between the control device and the light-emitting diode(s) implies that each luminaire containing one or more light-emitting diode(s) comprises its own control device, which implies, according to the state of the art, that two distinct wirings be used, one for delivering the power supply to each luminaire, using for instance a connection to an a.c. energy distribution system, and the other for delivering the signals to be transmitted by each luminaire.

According to the prior art, the question of the means for delivering the signals to be transmitted to the light-emitting diodes is not addressed in a manner satisfactory for all applications, since the use of two separate wirings is obviously more expensive than a classical wiring for luminaires only intended for lighting. In order to use only one wiring, one could plan to deliver the signals to be transmitted to each luminaire using a radio link, but this solution cancels the main advantage of free-space optical transmission, which is that it does note use the radio spectrum.

### DESCRIPTION OF THE INVENTION

The purpose of the invention is a transmitting device for free-space optical transmission which does not require a separate wiring for delivering its input signals, without the limitations of known methods and devices.

The invention is about a transmitting device for free-space optical transmission, comprising:

one or more light-emitting diodes used as light source for the optical transmission,

a receiving set for transmission via power distribution lines, capable of delivering “demodulated signals” at its output, the “demodulated signals” being obtained from a demodulation of signals appearing at the terminals allowing to power-feed the transmitting device,

a control device which modulates the light produced by the light-emitting diodes used as light source for the optical transmission, as a function of the “demodulated signals”.

The persons skilled in the art understand that, at a distance of the device of the invention large enough compared to the largest dimension of the device of the invention, it is possible to measure, in each direction, the radiant intensity of the light produced by the light-emitting diodes. A device of the invention may be such that the light which is emitted by all said light-emitting diodes used as light source for the optical transmission does not produce, in any solid angle less than 0.005 steradian, a radiant flux greater than 50% of the total radiant flux produced by all said light-emitting diodes used as a light source for the optical transmission. When this requirement is fulfilled, this total radiant flux cannot be focused in a very narrow beam of light and the corresponding modulated light is therefore radiated with a low directivity by the device of the invention. For instance, with a laser, more than 50% of the total radiant flux is usually contained in a beam of light which, at a large enough distance, corresponds to a cone, the vertex angle of which is less than 2 milliradians, that is to say a solid angle less than about 3.10⁻⁶ steradian. According to the invention, when said requirement is fulfilled, the light produced by the light-emitting diodes must therefore be emitted in a solid angle much larger than the solid angle of the lasers typically used in commercially available devices for free-space optical transmission between buildings. This characteristic renders useless a precise alignment between a device according to the invention and a receiver for optical transmission, which can therefore be mobile. However, the use of a relatively large solid angle of emission (that is to say a low directivity) leads to a relatively shorter transmission range.

Consequently, a device of the invention may be such that it is designed to be installed inside a building, or inside a vehicle. A device of the invention complying with the requirement which is defined above is for instance suitable for transmission toward receivers for optical transmission carried by persons moving inside a building or a vehicle.

The receiving set for transmission via power distribution lines exploits signals appearing at the power-feeding terminals of the transmitting device of the invention. These power distribution lines may belong to any kind of energy distribution system, for instance a d.c. energy distribution system, an a.c. energy distribution system connected to the public low-voltage network, a shipboard power distribution system, etc.

The receiving set for transmission via power distribution lines is the receiving part of a system for transmission via power distribution lines which can also be called “power-line communication” or “PLC” in English. The characteristics and possible implementations of such a system are well known to specialists, several aspects being presented in the article of N. Pavlidou, A. J. Han Vinck, J. Yazdani and B. Honary entitled “Power Line Communication: State of the Art and Future Trends” published in the IEEE Communications Magazine, Vol. 41, No. 4, April 2003, pages 34 to 40. It should be noted that, according to the regulations applicable in the European Union, the frequencies allocated to some transmissions via power distribution lines are higher than 3 kHz. According to the invention, the receiving set for transmission via power distribution lines may therefore obtain the “demodulated signals” from a demodulation of signals of frequencies higher than 3 kHz appearing at the terminals allowing to power-feed the transmitting device.

The signals transmitted by the system for transmission via power distribution lines may be digital signals or analog signals, obtained using any digital or analog modulation method.

The article of E. Biglieri entitled “Coding and Modulation for a Horrible Channel” published in the IEEE Communications Magazine, Vol. 41, No. 5, May 2003, at the pages 92 to 98, teaches us that, for transmission via power distribution lines, the modulation of a single carrier is often not a good technical solution. Consequently, a device of the invention may be characterized in that the receiving set for transmission via power distribution lines uses a modulation method using several carriers or a spread spectrum technique. For instance, modulation method using several carriers, such as the orthogonal frequency-domain multiplex (also referred to as OFDM), may give good results.

The diode current may be modulated in many ways well-known to specialists. According to the invention, it is for instance possible to use an optical on-off keying (OOK) to modulate the light. For instance, in order to transmit an analog signal, it is possible to use a pulse frequency modulation (PFM) of the diode current to obtain an optical on-off keying. For instance, in order to transmit digital information, it is possible to use a baseband diode current in coded marked inversion mode (CMI mode), to obtain an optical on-off keying. For instance, in order to transmit digital information, it is possible to use a pulse position modulation (PPM) of the diode current to obtain an optical on-off keying.

According to the invention, it is for instance possible to use a current flowing always in the same direction, made up of a direct current on which a zero average variable current is superimposed, in order to obtain an optical intensity modulation (IM) to modulate the light. For instance, in order to transmit digital information, the zero average variable current may be a baseband current implementing a diphase code (also known as biphase-level code, or Manchester code) or a high density bipolar encoding (HDB3), well-known to specialists, to obtain an optical intensity modulation. For instance, the zero average variable current may be a subcarrier modulated in any way by analog or digital information to be transmitted, to obtain an optical intensity modulation. The subcarrier may be modulated according to any method involving a variation of its phase or of its frequency, for example a frequency-shift keying (FSK) for a numerical signal. The subcarrier may also be modulated according to any method involving a variation of its amplitude. It is also possible to use several subcarriers.

It is clear for the person skilled in the art that, in order to obtain an optical intensity modulation, the various types of modulation of the diode current may for instance be obtained using a variation of the duty cycle of a switch-mode control device.

In general, it is desirable that the modulation of light be imperceptible by human observers. This result may be obtained when the light-emitting diodes used as light source for the optical transmission produce alight invisible to human observers. A device of the invention may therefore be characterized in that the light-emitting diodes used as light source for the optical transmission produce a light invisible to human observers, for instance infra-red light. In such a device of the invention, it is possible that visible light is produced by at least one light source which is not used for optical transmission, for instance by one or more discharge lamps or by white light-emitting diodes which are not used for the optical transmission. Such a device of the invention may be characterized in that the visible light produced by the transmitting device of the invention is also used for lighting.

A modulation of the light imperceptible by human observers may be obtained when the light-emitting diodes used as light source for the optical transmission produce a visible light, thanks to the phenomenon of the persistence of vision, which eliminates the perception of flicker for fast enough luminous variations. A device of the invention may therefore be characterized in that the variation of the luminous flux corresponding to the modulation of light contains practically no components at frequencies less than 24 Hz. For some modulations, this limit of 24 Hz will be appropriate for having no perception of the presence of a modulation by a human observer. For some modulations, it might be useful to use a higher limit, for instance 200 Hz. For example, this characteristic may be easily obtained with an optical on-off keying and a diode current in coded marked inversion mode, or with an optical intensity modulation and a diode current having a variable part implementing the Manchester code. Such a device of the invention may be characterized in that the visible light produced is also used for lighting.

A device of the invention which produces a light suitable for lighting may be designed in such a way that it looks like an ordinary luminaire. Consequently, a transmitting device of the invention may be characterized in that its free-space optical transmission function is secret, the apparent function of the transmitting device being lighting.

### BRIEF DESCRIPTION OF THE DRAWING

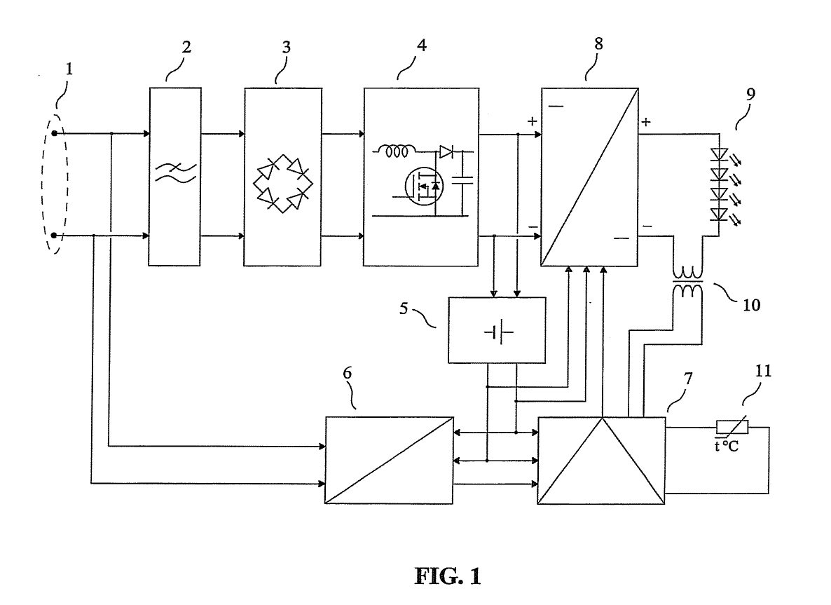

Other advantages and characteristics will appear more clearly from the following description of a particular embodiment of the invention, given by way of non-limiting example, with reference to the accompanying drawing of FIG. 1, which shows an embodiment of the invention.

### DETAILED DESCRIPTION OF AN EMBODIMENT

As an example of a device of the invention, given by way of non-limiting example, we have represented in FIG. 1 a device of the invention connected by its input terminals (1) to an a.c. energy distribution system. A mains filter (2) allows to effectively reduce the conducted electromagnetic disturbances produced at frequencies higher than 150 kHz by the power circuits, in accordance with the regulation concerning electromagnetic compatibility. The power circuits comprise a rectifier (3), a power-factor-correction circuit (4), an auxiliary power supply (5) and a DC-to-DC converter (8). The power-factor-correction circuit (4), well known to specialists, is a non-isolated boost converter. It draws a sinusoidal current from the mains. It therefore provides a low emission of harmonic currents, in accordance with the regulation concerning electromagnetic compatibility. It also provides pre-regulation. The DC-to-DC converter (8) comprises a flyback power supply. The output of the DC-to-DC converter (8) is connected to several high power light-emitting diodes connected in series (9), these diodes being connected in series with the secondary of a modulation transformer (10). The output of the DC-to-DC converter (8) is current-regulated, and therefore has a high dynamic impedance at frequencies below 1 Hz. The output of the DC-to-DC converter (8) has a low dynamic impedance at frequencies above 1000 Hz, thanks to its output filtering capacitor. The primary of the modulation transformer (10) receives a modulation current which is supplied by the control circuitry (7) implementing a class D output stage. The modulation current is obtained through a minimum shift-keying modulation (MSK) of a subcarrier at 375 kHz, with a digital signal at 500 kbits/s, such a modulation having a spectral density of zero at the frequency 0 Hz. The light-emitting diodes (9) receive therefore a direct current supplied by the DC-to-DC converter (8), this direct current being superimposed to a zero average current delivered by the secondary of the modulation transformer (10). A receiving set for transmission via power distribution lines (6) delivers demodulated signals at its output, the demodulated signals being obtained from a demodulation of signals of frequencies higher than 3 kHz appearing at the two input terminals (1). These demodulated signals are applied to the input of the control circuitry (7) which provides at a first output the current command of the DC-to-DC converter (8) and at a second output the modulation current applied to the primary of the modulation transformer (10). The signals at the output of the control circuitry (7) depend on the temperature which is measured by a temperature sensor (11) and on the demodulated signals, in such a way that the light produced by the light-emitting diodes (9) is suitably modulated and that the mean current flowing through the light-emitting diodes has an appropriate value for their temperature. The control circuitry (7), the DC-to-DC converter (8), the modulation transformer (10) and the temperature sensor (11) make up a switched-mode control device which modulates the diode current as a function of the demodulated signals, in such a way that the light produced is also modulated as a function of the demodulated signals, with few losses thanks to the use of said flyback power supply and a class D output stage. The auxiliary power-supply (5) feeds the receiving set for the transmission via power distribution lines (6), the control circuitry (7) and the DC-to-DC converter (8).

We note that the control circuitry (7) could also be linked to a light intensity sensor, comprising for instance a photodiode, in such a way that the signals supplied by the control circuitry depend on the radiant flux produced by the light-emitting diodes, because the ageing of high-power light-emitting diodes often decreases the luminous flux. We also note that it would in theory be possible to obtain a modulation of the diode current using a variation of the current command of the DC-to-DC converter (8), which could allow to eliminate the need for the modulation transformer (10) and the second output of the control circuitry (7). In fact this solution could be suitable for a slow modulation, but, for the modulation considered in this example, this solution is in practice not compatible with low losses.

No earthing, grounding, or connection to a protective ground wire at the level of the input terminals (1) appears in FIG. 1. Such connection may obviously be present, for instance for electrical safety and/or for electromagnetic compatibility.

The modulation of the light produces a very low spectral density at frequencies below 10 kHz and is therefore imperceptible. We also note that, if the light-emitting diodes (9) are white light-emitting diodes, the chosen method of modulation avoids the phenomena of the change of color described in the French patent application number 02 15359 mentioned above.

The device according to the example shown in FIG. 1 is built in such a way that it looks like a common luminaire, only intended for lighting. The demodulated signals may also be used for functions other than the modulation of light, for instance for functions related to the lighting function, such as on/off switching or the variation of the lighting intensity (dimming function).

### INDICATIONS ON INDUSTRIAL APPLICATIONS

Thanks to a device of the invention, the signals sent by the transmitter of a system for transmission via power distribution lines are transformed into optical signals which may be received using a suitable receiver for optical transmission. This optical transmission allows a transmission without wire and without radio. The optical signals transmitted in this manner may correspond to voice, data, etc. These optical signals may also comprise other information which originates internally from the device of the invention, for instance relating to the ageing of the light-emitting diodes, which may be deduced from some electrical quantities of the control device or from a measurement of the emitted light intensity, as is well known to specialists.

A device of the invention may be such that the emission of modulated light for the transmission of a data set takes place at a well determined time, for instance using a synchronization with respect to the signals transmitted via the energy distribution system. In this way, several devices of the invention may each produce a modulated light, these modulations being identical and in phase. This will increase the signal received by a receiver for optical transmission which would receive the light produced by several of these devices of the invention.

It is also possible that several different devices of the invention connected to the same energy distribution system produce different optical signals, using an addressing scheme well known to specialists.

The device for free-space optical transmission of the invention is particularly suitable for broadcasting information inside buildings and vehicles, in a manner totally immune to radio frequency disturbances and electromagnetic interferences of external origin. Many applications are possible, for instance the application to the transmission of data on prices in commercial premises used for mass marketing.

The device of the invention may particularly be implemented in emergency transmission systems in buildings, because in the context of an accident of large extent or of a disaster, the capacity of radio transmissions are often saturated or very disturbed. For this application, a device of the invention could also have a safety lighting function.

The device of the invention may particularly be implemented in a transmission system in a vehicle, the transmission system producing no radiofrequency electromagnetic disturbances.

The device of the invention may particularly be implemented in a transmission system in a medium which is transparent but sufficiently conductor to limit the possibilities of radiocommunications, like sea water.

The device of the invention may particularly be implemented in a transmission system in places where intense electromagnetic disturbances limit the possibilities of radiocommunications.

Since it does not use radio transmission likely to be picked up at a distance, the device of the invention is particularly suitable for secret transmissions, especially when the light it produces cannot reach a receiver for optical transmission, when this light is not intended for this receiver.

1. A transmitting device for free-space optical transmission, comprising:
one or more light-emitting diodes used as light source for optical transmission,
a receiving set for transmission via power distribution lines, capable of delivering “demodulated signals” at its output, the “demodulated signals” being obtained from a demodulation of signals appearing at the terminals allowing to power-feed the transmitting device,
a control device which modulates the light produced by the light-emitting diodes used as light source for the optical transmission, as a function of the “demodulated signals”.

2. The transmitting device of claim 1, wherein the light emitted by all said light-emitting diodes used as light source for the optical transmission does not produce, in any solid angle less than 0.005 steradian, a radiant flux greater than 50% of the total radiant flux produced by all said light-emitting diodes used as a light source for the optical transmission.

3. The transmitting device of claim 1, wherein the receiving set for transmission via power distribution lines uses a modulation method using several carriers or a spread spectrum technique.

4. The transmitting device of claim 1, wherein an optical on-off keying is used to modulate the light.

5. The transmitting device of claim 1, wherein an optical intensity modulation is used to modulate the light.

6. The transmitting device of claim 1, wherein the light-emitting diodes used as light source for the optical transmission produce a light invisible to human observers.

7. The transmitting device of claim 1, wherein visible light is produced by at least one light source which is not used for optical transmission.

8. The transmitting device of claim 1, wherein the light-emitting diodes used as light source for the optical transmission produce a visible light, the modulation of the light being imperceptible by human observers.

9. The transmitting device of claim 1, wherein the visible light produced by the transmitting device is also used for lighting.

10. The transmitting device of claim 1, wherein the free-space optical transmission function is secret, the apparent function of the transmitting device being lighting.
